(19) United States
(12) Patent Application Publication
(10) Pub. No.: US 2012/0105308 A1
(43) Pub. Date: May 3, 2012

(54) SPHERICAL DISPLAY DEVICE

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/163,718

(22) Filed: Jun. 19, 2011

(30) Foreign Application Priority Data
Oct. 29, 2010 (CN) 201010524986.4

(51) Int. Cl. G09G 5/00

(52) U.S. Cl. 345/1.3

(57) ABSTRACT

A spherical display device includes a frame, a plurality of first display units and a plurality of second display units fixed on the frame. The first display panel units and the second display panel units being joined together and electrically connected to each other to cooperatively form a spherical structure with a spherical display surface. When the first display units and the second display units work together to corporately display an object, viewers can view the object in view angle of 360 degree.

### BACKGROUND

1. Technical Field

The present disclosure relates to display devices and, particularly, to a spherical display device.

2. Description of Related Art

Many wide angle visual displays have been made and are being wildly used. For example, a known LCD device having viewing angle of about 170 degrees for a special polarizing film with many microstructures is being used. In another example, the display panel can also be curved to improve the visual angle. However, neither of the display panels mentioned above can show the display content in a range of 360 degrees.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an isometric view of a spherical display device in accordance with an exemplary embodiment.

FIG. 2 is a schematic view of a frame of the spherical display device of FIG. 1.

FIG. 3 is a part cross-sectional view of the spherical display device of FIG. 1, taken along line II-II.

FIG. 4 is a part cross-sectional view of the spherical display device of FIG. 1, taken along line II-II, in accordance with an exemplary embodiment.

### DETAILED DESCRIPTION

Embodiments of the present disclosure are now described in detail, with reference to the accompanying drawings.

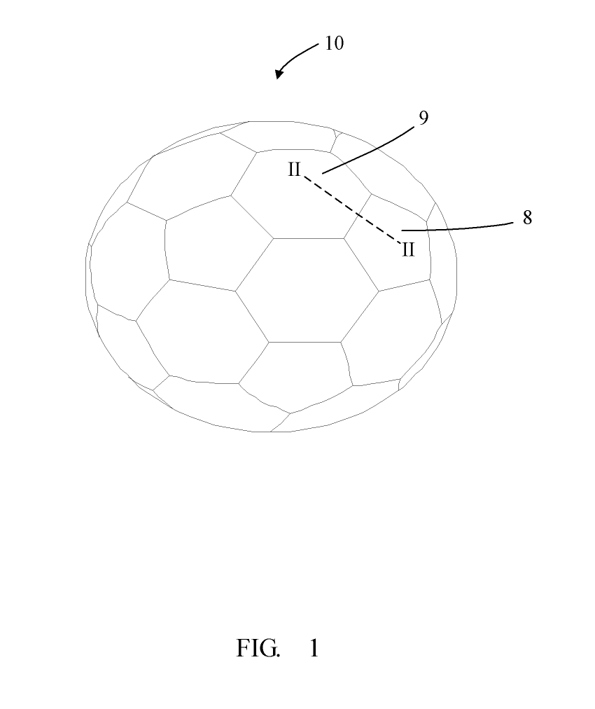

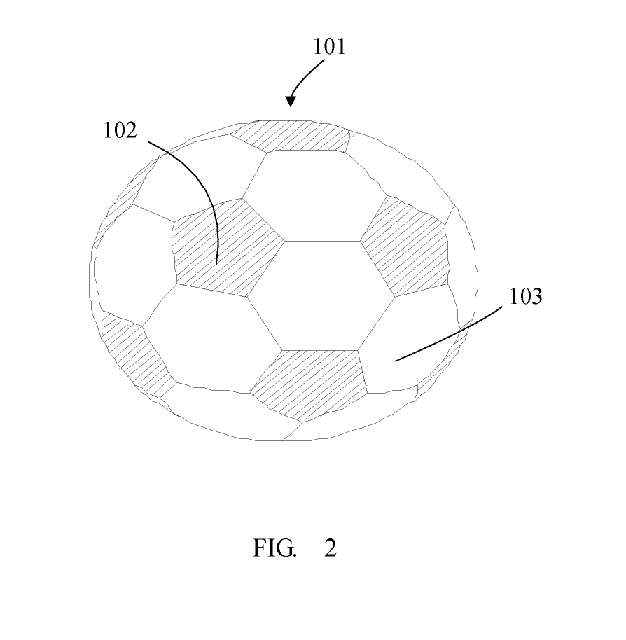

Referring to FIGS. 1 and 2, a spherical display device 10 includes a frame 101, a number of first display panel units 8 and a number of second display panel units 9. The first display panel units 8 and the second display panel units 9 are fixed on the frame 101. The spherical display device 10 further includes a display control unit (not shown) to control the first display panel units 8 and the second display panel units 9 to display information. Each of the first display panel units 8 and the second display panel units 9 can be controlled to display the same object, for example, all display an apple; or display different objects; for example, one displays an apple, another displays an orange, still another displays a banana. The first display panel units 8 and the second display panel units 9 can be controlled to work together to corporately display an object such as a world map.

In this embodiment, the frame 101 is spherical-like shape, and includes twelve regular pentagonal support structures 102 and twenty regular hexagonal support structures 103, similar to the structure of the fullerene C60. The first display panel units 8 are pentagonal and respectively supported by the regular pentagonal support structures 102 of the frame 101. The second display panel units 9 are hexagonal and respectively supported by the regular hexagonal support structures 103 of the frame 101. The first display panel units 8 and the second display panel units 9 are joined together and electrically connected to each other to cooperatively form a spherical structure with a spherical display surface. Each of the first display panel units 8 is jointed to and surrounded by five second display panel units 9. Each of the second display panel units 9 is jointed and surrounded by three first display panel units 8 and three other second display panel units 9, where the three first display panel units 8 and the three other second display panel units 9 are alternately arranged. The first display panel units 8 and the second display panel units 9 can be selected from the group consisting of LCD display panels, LED display panels, and E-paper display panels according to actual requirements.

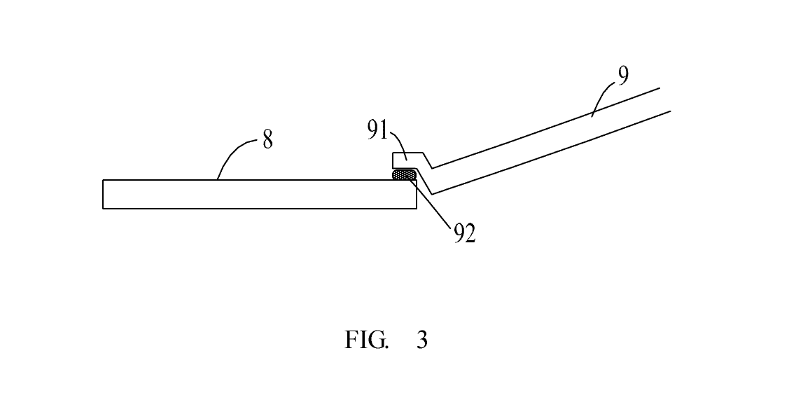

Referring to FIG. 3, each second display unit 9 includes three connecting portions 91 extending outward from the three alternate edges of the second display unit 9 that are joined to the display units 8. Each of the connecting portions 91 can be electrically connected to the corresponding edge of the adjacent first display unit 8 via an anisotropic conductive film (ACF) 92.

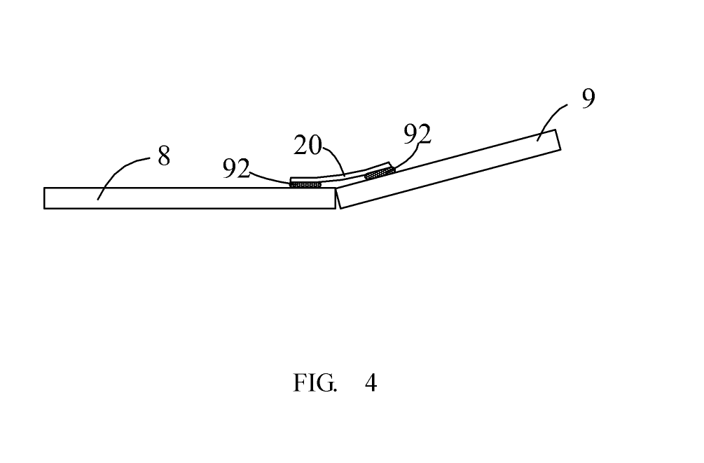

Referring to FIG. 4, in an alternative embodiment, the spherical display device 10 further includes a number of flexible printed circuits (FPCs) 21. The second display unit 9 and the first display unit 8 are electrically connected to the FPCs 21 via an ACF 92. Thus the second display panel units 9 and the first display panel units 8 are electrically connected together.

When the first display panel units 8 and the second display panel units 9 work together to corporately display an object, viewers can view the object in view angle of 360 degree. In addition, each of the first display panel units 8 and the second display panel units 9 can display objects separately and independently, this display manner is used to offer more viewers to watch the display in different direction at the same time.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A spherical display device, comprising:
a frame; and
a plurality of first display panel units and a plurality of second display panel units fixed on the frame, the first display panel units and the second display panel units being joined together and electrically connected to each other to cooperatively form a spherical structure with a spherical display surface.

2. The spherical display device according to claim 1, wherein the frame is substantially spherical, and comprises twelve regular pentagonal support structures and twenty regular hexagonal support structures to respectively support the first display units and the second display units.

3. The spherical display device according to claim 1, wherein the number of the first display units is twelve and each first display unit is regular pentagonal, and the number of the second display units is twenty and each second display unit is regular hexagonal.

4. The spherical display device according to claim 3, wherein each first display unit is jointed to and surrounded by five second display units.

5. The spherical display device according to claim 3, wherein each second display unit is jointed to and surrounded by three first display units and three other second display units, the three first display units and the three other second display units are alternately arranged.

6. The spherical display device according to claim 1, further comprising a plurality of anisotropic conductive films, each second display unit is electrically connected to an adjacent corresponding first display unit via the anisotropic conductive film.

7. The spherical display device according to claim 1, further comprising a plurality of flexible printed circuit boards, and a plurality of anisotropic conductive films the second display units and the plurality of first display units are electrically connected to the corresponding flexible printed circuit boards via the anisotropic conductive films.

8. The spherical display device according to claim 1, wherein the first display panel units and the second display panel units are selected from the group consisting of LCD display panels, LED display panels, and E-paper display panels.
